(19) United States
(12) Patent Application Publication
(10) Pub. No.: US 2006/0224727 A1
(43) Pub. Date: Oct. 5, 2006

(54) Image communication apparatus

(75) Inventors: Shunichi Kumakura, Tokyo (JP); Madoka Kano, Warabi-shi (JP); Motoaki Aoyama, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/194,616

(22) Filed: Aug. 2, 2005

(30) Foreign Application Priority Data
Mar. 31, 2005 (JP) JP2005-100760

(51) Int. Cl. G06F 15/173; G06F 15/16

(52) U.S. Cl. 709/224; 709/247

(57) ABSTRACT

There is described an image communication apparatus in which the transmission efficiency is as high as possible for the network conditions at the time of transmission, and transmission can be performed using method of coding in which there is little image deterioration. The communication apparatus includes: a checking section that checks a quality of the network; a selector that determines one of methods of coding in accordance with the quality of the network; a coding section that codes an image data based on the coding method determined by the selector; a transmit section that transmits the coded image data to a desired destination via the network; and a storage section that stores a coding capability information of the desired destination. The selector determines the coding method in accordance with the quality of the network and the coding capability information.

### RELATED APPLICATION

This application is based on Japanese Patent Application No. 2005-100760 filed on Mar. 31, 2005 in Japanese Patent office, the entire content of which is hereby incorporated by reference.

### BACKGROUND

1. Field of the Invention

This invention relates to an image communication apparatus, which transmit image data via a network, and relates in particular to techniques for efficient transmission of image data and for controlling the effect of the deteriorating in the quality of the network on transmission results.

2. Description of the Related Art

In facsimiles, image data is commonly coded and compressed to reduce the amount of data and then the data is transmitted. There are various types of this method of coding and the compression rate of the image data is different for each method. As a result, in facsimiles that use public telephone lines, before transmission of image data is performed, the facsimile communicates with the transmission destination terminal using control signals, and the methods of coding that are usable at the transmission destination terminal (referred to as decoding capability hereinafter) are determined, and then the method of coding with the highest compression rate is selected from those that are usable by both the facsimile and the destination terminal, and high speed image data transfer is thereby achieved.

It is to be noted that internet facsimile technology is provided in which image data is processed via the internet in the same manner as with a facsimile. Two types of communication methods which are specified by communication regulations of the ITU-T (International Telecommunication Union Telecommunication Standardization sector) recommendation T.37 (referred to as T.37 hereinafter) and ITU-T recommendation T.38 (referred to as T.38 hereinafter) are being practically used in internet facsimile. It is also possible to select the respective method of coding in these types of internet facsimiles, (but in T.37, this is limited to full mode), and as is the case with the conventional facsimile, usually the method of coding with the highest compression rate is selected from those that are usable by both the facsimile and the destination terminal.

However, in reality, the compression rate of the image data depends on the content of the image data such as whether pictures are included, whether the document is black and white or color document, and furthermore the compression rate for a specific method of coding, will not continually increase. Thus, technology has been disclosed in which, in selecting the method of coding, all the methods of coding that are capable of decoding at the destination terminal are used and a plurality of coded data are stored. The method of coding which resulted in the smallest amount of data after coding is selected and the coded image data is transmitted (see Patent Document 1 for example).

[Patent Document 1]
Tokkai 2000-332941 (Japanese Non-Examined Patent Publication)

If the method with the highest compression rate of those methods that are usable by both the facsimile and the destination terminal is selected after actually measuring the amount of coded data, efficient image data transmission becomes possible. However, in the high compression rate method, there is a great amount of image deterioration even when only a portion of the image data is lacking or lost during image data transmission.

In particular, in the networks used by internet facsimile, sometimes damage such as packet loss or the like occurs during data transmission. In this case, if only transmission rate is prioritized in selecting the method of coding, for some methods of coding for which the compression rate is high, there is a high occurrence of decoded error in which the image data that has been coded cannot be decoded to its original form at the transmission destination terminal, and problems arise such as a greatly degraded image is output, or communication may be cut off.

### SUMMARY

In view of foregoing, an object of the present invention is to provide an image communication apparatus and a method of image data transmission in which the transmission efficiency is as high as possible for the network conditions at the time of transmission, and transmission can be performed using method of coding in which there is little image deterioration.

A communication apparatus which transmits an image data via a network, comprising:a checking section which checks a quality of the network; a selector which determines one of methods of coding in accordance with the quality of the network; a coding section which codes an image data based on the coding method determined by the selector; and a transmit section which transmits the coded image data to a desired destination via the network.

A method for transmitting image data through a network, comprising the steps of: checking a quality of the network; determining one of methods of coding in accordance with the quality of the network; coding the image data based on the coding method determined in the determining step; and transmitting the coded image data to a desired destination through the network.

According to the abovementioned invention, the quality of the network when image data is being transmitted by internet facsimile is checked, and a method of coding is selected based on the results. For example, methods of. coding for which image deterioration is unlikely even if image data is lacking, as in the case of packet loss and the like, may be selected to the extent that the quality of the network is poor.

The invention itself, together with further objects and attendant advantages, will best be understood by reference to the following detailed description taken in conjunction with the accompanying drawings.

### BRIEF DESCRIPTION OF THE DRAWINGS

Other objects and advantages of the present invention will become apparent upon reading the following detailed description and upon reference to the drawings in which:

FIG. 1 is a block diagram showing the configuration of the image communication apparatus of an embodiment of this invention;

FIG. 2 is an explanatory diagram for describing an example of the capability recorded in the MDN response which is received from the destination terminal in order to retrieve decoding capability of the destination terminal;

FIG. 3 is an explanatory diagram showing an example of the configuration of the network which uses the image communication apparatus of an embodiment of this invention to transmit image data;

FIG. 4 is an explanatory diagram showing an example of a coding method selection chart which is the reference for selecting a method of coding based on the quality of the network when the image communication apparatus of an embodiment of this invention transmits image data;

FIG. 5 is a flowchart showing the operation performed when the time until the checking section receives a response signal for the check signal is measured and the quality of the network is checked;

FIG. 6 is a flowchart showing the operation performed when the quality of the network is checked based on the condition for receiving a check data which the checking section obtains from a predetermined site;

FIG. 7 is a flowchart showing the operation of the image communication apparatus which selects a method of coding based on the quality of the network and transmits image data using a T.37 internet facsimile;

FIG. 8 is a flowchart showing the operation of the image communication apparatus which selects a method of coding based on the quality of the network and transmits image data using the internet facsimile based on T.38; and

FIG. 9 is a flowchart showing the operation of the image communication apparatus which checks the resend request for image data from the destination terminal and transmits image data.

In the following description, like parts are designated by like reference numbers throughout the several drawings.

### DETAILED DESCRIPTION OF THE PREFERRED EMBODIMENT

The following is a description of the embodiments of this invention with reference to the drawings.

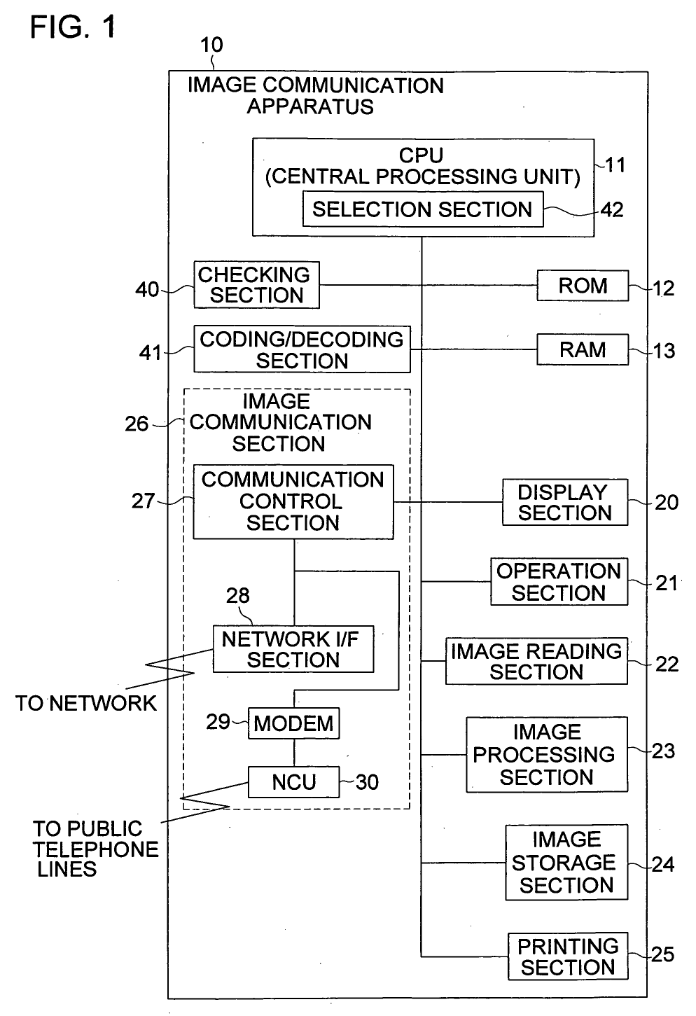

FIG. 1 shows the electrical configuration of the image communication apparatus 10 relating to an embodiment of this invention.

The image communication apparatus 10 has multiple functions which include: facsimile function and internet facsimile function for transmitting and receiving image data via a network and public telephone lines; copier function for reading a document and forming duplicated images thereof on a recording medium; scanner function for outputting the read image data to the outside; and a printer function for printing based on received print data.

The image communication apparatus 10 is formed of circuits including a CPU (Central Processing Unit) 11 which is the control section that performs integrated control of the operations; a ROM (Read Only Memory) 12; and a RAM (Random Access Memory) 13 as its main components.

The ROM 12 stores the program, which the CPU 11 executes, as well as various fixed data used in execution of the program. The RAM 13 functions as a work memory for temporarily storing various data when the CPU 11 executes programs and as a page memory for storing image data in at least one page of the image data in order to perform image processing, e.g. rotation processing.

Furthermore, the CPU 11 has connected thereto a display section 20; a operation section 21; a image reading section 22; a image processing section 23; a image storing section 24; a printing section 25; and a image communication section 26.

The display section 20 is formed of a liquid crystal display and functions to display various information and status for the user.

The operation section 21 is formed of a touch panel which covers the various operation switches and the surface of the display section 20, and accepts various operations performed by the user.

The image reading section 22 performs the function of reading the images on a document and taking in the corresponding image data. The image reading section 22 includes: a light source which irradiates the document; a line image sensor which reads one-line portions of the document in the horizontal direction thereof; a moving section which moves the reading position of the line unit in the length direction of the document; and an optical path which is formed of lens and mirrors for leading light reflected from the document to the line image sensor and focusing the light. The line image sensor includes a CCD (Charge Coupled Device). The analog image signals that the line image sensor output are subjected to A/D (Analog/Digital) conversion, and taken in as digital image data.

The image processing section 23 performs the functions such as enlarging and reducing image data and rotating the images.

The image storing section 24 is a large capacity memory device which stores compressed image data and the like. In this embodiment a magnetic disk device (HDD: Hard Disk Drive) is used.

The printing section 25 performs the function of forming images corresponding to the image data on a recording medium using an electophotographic process and outputting the images. The printing section 25 is configured as a so-called laser printer which includes a recording paper conveying device; a photoreceptor drum; a charging device; a laser unit; and a development device; a transfer and separation device; a cleaning device; and a fixing device.

The image communication section 26 functions as a transmission section and a receiving section for transmitting and receiving image data via a network or public telephone lines. The image communication section 26 includes an image communication section 27, a network I/F (Interface) section 28, a modem 29 and a NCU (Network Control Unit) 30.

The communication control section 27 transmits and receives image data based on the transmission procedure of the internet facsimile via the network. More specifically, the communication control section 27 functions as a T.37 and/or T.38 internet facsimile.

In the case of the T.37, the image data may be attached to electronic mail and sent. In the case of T.38, the image data is sent in real time using the same pre-transmission procedure as in the case of the G3 (Group 3) facsimile which uses public telephone lines. This differs from the normal G3 facsimile in that the data is sent via the network by packet communication.

In the case where image communication is performed using the internet facsimile based on T.37, the communication control section 27 converts the image data to TIFF (Tagged Image File Format) and MIME (Multipurpose Internet Mail Extension) format electronic mail to which the converted image data is attached is created. This electronic mail is then sent via the network to a server at which the mail address of the destination terminal is registered. In addition, the communication control section 27 has the function of periodically receiving electronic mail from a mail server having its mail address registered and obtaining the image data that is attached to the electronic mail when the image data is received. In order to attach image data to electronic mail and perform handling, the destination terminal is not limited to a facsimile device and the internet facsimile based on T.37 may transmit and receive image data to and from the internet or a PC (Personal Computer) which is connected to the same LAN (Local Area Network).

In addition, in the case where the communication control section 27 performs image communication using the internet facsimile based on T.38, various control signals and image data based on the pre-transmission procedures of the G3 facsimile which is standardized by ITU-T recommendation T.30 are included in the IFP (Internet Facsimile Protocol) packet and the communication control section 27 performs internet communication with the destination terminal. As a result, image data can be sent and received in real time as is the case with the facsimile using the public telephone lines.

It is to be noted that the configuration of the image communication apparatus 10 may be such that it is applicable to any of two types of internet facsimiles which are the T.37 and T.38, or alternatively it may be applicable to both types.

The network I/F section 28 uses the UDP (User Datagram Protocol) or the TCP (Transmission Control Protocol) under the control of the communication control section 27 and functions to transmit and receive image data between external devices via the internet or a LAN.

The communication control section 27 also functions to transmit and receive image data by facsimile via the public telephone lines. More specifically, the communication control section 27 has typical facsimile functions of handling various control signals and image data between itself and the destination terminal based on the post-transmission procedure of the T.30 G3 facsimile.

The modem 29 is a modulator-demodulator which converts digital data to sound signals so that they can be transmitted on an analog circuit and then converts the sound signals to digital data. The modem 29 is installed between the communication control section 27 and the NCU 30 and performs the function of converting data to a format that is usable at the respective apparatus and then outputting the data.

The NCU 30 is a circuit which controls connection with the public telephone lines and performs the function of detecting inversion of the telephone line and detecting call signals.

The image communication apparatus 10 also includes a checking section 40 and a coding/decoding section 41. The checking section 40 performs the function of checking the quality of the network used by the internet facsimile.

The coding/decoding section 41 functions as coding device which codes the image data to be transmitted using a predetermined method of coding and then outputs the coded image data to the image communication section 26. The image data is compressed by being coded, and the image data amount is reduced when compared to the amount prior to coding. In addition, the coding/decoding section 41 functions a decoding device which decodes the image data received at the image communication section 26 and returns the image data to the state prior to coding.

The coding/decoding section 41 can code and decode the image data using each of methods of coding which include MH (Modified Huffman), the MR (Modified Read), MMR (Modified Modified Read), and the JBIG (Joint Bi-level Image Experts Group).

MH is a method of coding with the lowest image data compression rate. MH is a method of one-dimensional coding which performs coding in one line image data units when the image reading section 22 reads a document as a facsimile using the line image sensor. For this reason, MH is characterized by the fact that the effect of image data damage is restricted only to the line including the damaged locations.

MR is a method of coding that has a medium level image data compression rate. MR is a method of two-dimensional coding which performs coding in units of two lines or four lines, and is characterized by the fact that the effect of damage to image data spreads to the two lines or four lines that include the damaged location.

MMR and JBIG are methods of coding with the highest image data compression rate of the methods of coding handled by the coding/decoding section 41. The MMR and the JBIG cannot both be unconditionally said to have high compression rates, but both are methods that perform coding of entire image data in units. For this reason, a feature of these methods is the fact that due to loss of a part of the image data, reproduction becomes impossible for a wide range within the image.

The CPU 11 functions as a selector 42 which selects the method of coding when image data is transmitted to the destination terminal using the internet facsimile. The selector 42 selects a method of coding which is unlikely to be affected by deterioration in the decoded image data within the range of the decoding capability of destination terminal. This selection is done based on the quality of the network obtained by the checking section 40 and the decoding capability of the destination terminal which is obtained by a method described below. This is because abnormalities in the coded image data cause deterioration (loss) of the decoded image data or decoding error to the extent that the quality of the network is poor.

Next, the method for obtaining the decoding capability of the destination terminal in the case of the T.37 and the T.38 image communication apparatus 10 are each described.

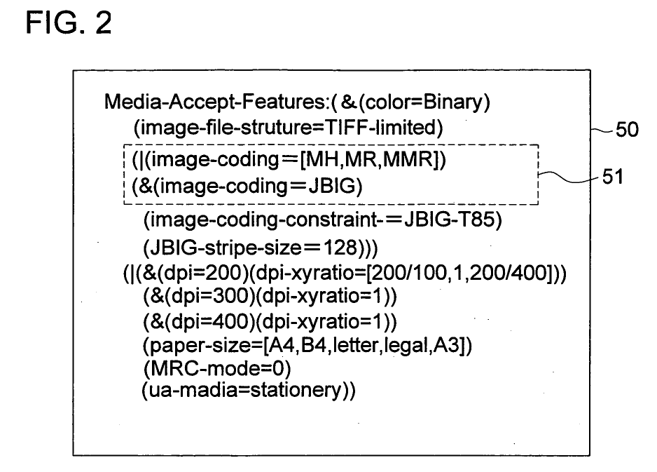

FIG. 2 is an example of the capability recorded in the MDN (Message Disposition Notification) response 50 used for obtaining the decoding capability of the destination terminal in the internet facsimile based on T.37.

MDN is a format which checks as to whether mail is read or un-read as defined by the RFC (Request For Comment) 2298 announced by the IETF (Internet Engineering Task Force) which is an organization for standardizing techniques used on the internet. If the image communication apparatus 10 writes a request for notification of reply reading or un-reading in the header section of the electronic mail to which image data is attached, the destination terminal replies by electronic mail with the MDN response 50 as the notification of reading or un-reading.

The MDN response 50 has information such as the decoding capability and resolution of the destination terminal written in a predetermined format. The information in the MDN response 50 is used for determining the decoding capability of the destination terminal in subsequent transmissions. It is to be noted that if the destination terminal is one to which data is being transmitted for the first time, because the information relating to decoding capability has not yet been obtained, only MH which is the standard method of coding for the T.37 is selected.

The section 51 which is enclosed by the broken lines in the drawing has the encoding capability of the destination terminal recorded therein. In this example, the fact that the destination terminal has decoding capabilities for MH, MR, MMR and JBIG is recorded.

On the other hand, in the internet facsimile based on T.38, the coding capability of the destination terminal is obtained by processing of the control signal based on the T.30 pre-transmission procedure. More specifically, the decoding capability of the destination terminal is obtained by signals which give notification of the standard functions of the called user base (the destination terminal in this embodiment) called the DIS (Digital Identification Signal).

In both the internet facsimile based on T.37 and the internet facsimile based on T.38, the obtained information relating to the decoding capability of the destination terminal is stored in a predetermined storage section, and this storage section and the CPUll form a decoding capability information storage section.

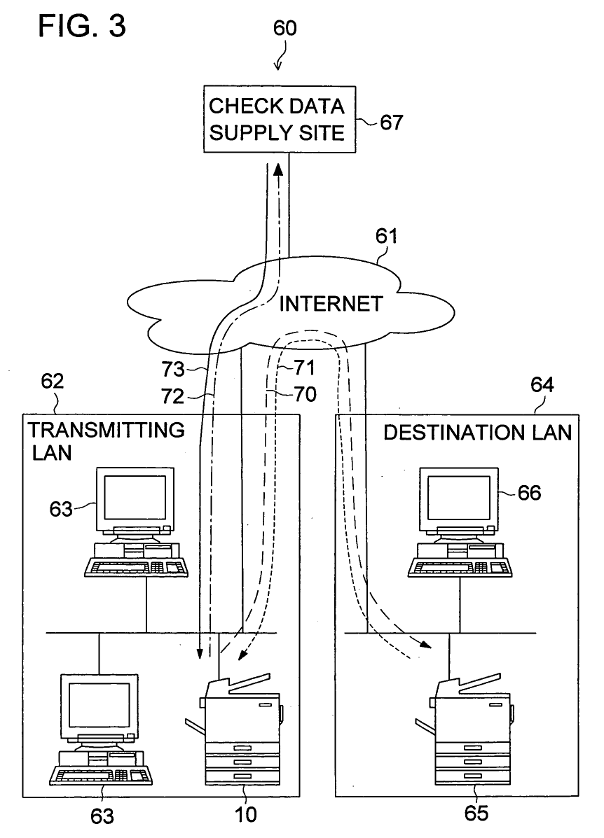

FIG. 3 shows an example of the configuration of the network system which transmits image data using the image communication apparatus 10 of an embodiment of this invention.

The network 60 includes the LAN 62 and the destination LAN 64 which are connected to the internet 61.

The LAN 62 is a LAN in which the image communication apparatus 10 at the transmission side and the PC 63 and the like are connected to the LAN 62.

The destination LAN 64 is a LAN in which the copier 65 which is the destination terminal at the receiving side and the PC 66 are connected.

Next, a first method and a second method will be described as methods for checking the quality of the network. The quality of the network as used herein refers to quality relating to whether transmitted image data reaches the destination terminals 65 or 66 in a normally. More specifically, it refers to the quality relating to whether image data arrives at the destination terminals 65 or 66 within the required time using a suitable procedure without image data being damaged or lost.

In the first method, a ping (Packet Internet Groper) command is used. That is to say, a predetermined signal transmitted to the IP (Internet Protocol) address of the destination terminal is used due to the ping command as the check signal 70 (shown as a coarsely broken line arrow in the drawings). In the ping command, four packets having 32-byte data portions are created and the check signal 70 is transmitted to a specified IP address every other second. The IP address is a 32 bit address for identifying a device which communicates on the internet.

The response signal 71 (shown as a fine broken line arrow in the drawing) is a signal which the destination terminal receiving the check signal 70 transmits to the IP address of the image communication apparatus 10. The destination terminal sends back the check signal 70 transmitted by the ping command in the same state it was received as the response signal.

The checking section 40 measures the level of congestion of the network based on the response time from when the check signal 70 is transmitted to when the response signal 71 is received and the quality of the network is estimated based on the measured results. Estimating the quality of the network based on the response time herein means that for circuits with a long response time, the network is congested, and the possibility of the occurrence of image data loss is high in a network that is congested. Standard use of the ping command is possible provided that the apparatus is one which can communicate on the internet 61. Thus by using the ping command, it is possible to check the quality of the network 60 without requiring any special devices.

It is to be noted that the example described herein is one in which the ping command is sent to a desired destination terminal which transmits image data, but the ping command may instead be sent to a predetermined terminal and the quality of the network can be checked by measuring the response time.

In the second method, the check data supply site 67 which supplies check data is provided on the internet 61. The image communication apparatus 10 which is connected to the LAN 62 sends a predetermined transmission request command 72 (shown by a broken line with single-dots in the drawing) to the check data supply site 67 and check data 73 (shown by the solid line arrow in the drawing) is received from the check data supply site 67 as a corresponding response.

The check data 73 is data for checking the quality of the network and includes, for example, prescribed data formed of 100 packets. The checking section 40 stores the content of correct check data 73 in advance and the quality of the network 60 is checked by comparing this stored check data 73 with the check data 73 received from the check data supply site 67. For example, the checking section 40 can check the quality of the network 60 by using the generation rate of packet damage or loss, problems with the packet arrival order, or by comparing the time it takes to receive the check data 73 with the timeout time.

In this embodiment, the check data supply site 67 is provided on the internet, but it may also be provided on the destination LAN 64. In this case, because the check data supply site 67 is on the same destination LAN 64 as the destination terminal, it is possible to determine a quality of the network similar to the conditions when image data is actually transmitted and received. Furthermore, the check data supply site 67 may be a built-in function in the destination copier 65. In this case, it is possible to determine the actual quality of the network on the communication path between the terminals.

By using the check data supply site 67, the content of the check data 73 and the content for checking can be flexibly set and the quality of the network 60 can be determined in more detail.

It is to be noted that the image communication apparatus 10 may use both or one of the first method and the second method to check the quality of network. In the case where the first method and second method are used together, the final determination of the quality of the network may be done using weighted check results of both methods.

In addition, a common index for the comparing the quality of the network checked with each of the methods using the same standard is expressed as numerical value. The degree of the quality of the network is an index expressed as a numerical value from 0-100. The method for converting the quality of the network checked using each of the methods to a numerical value which is the degree of the quality of the network may be set based on rule of thumb and on theoretical values. Also in the case where qualities of the network checked using a plurality of methods are combined to obtain the degree of the quality of the network, the degree of the quality of the network from each of the methods may be multiplied by weighting coefficients and then summed. In this case, the sum of the weighting coefficients must be equal to “1”.

In this manner, the quality of the network may be finally classified into three levels which are high quality, medium quality and low quality using the obtained degree of the quality of the network as a reference in this embodiment. More specifically, if the degree of the quality of the network is in the range 100-90 the network falls in the high quality level, if it is the range 90-20, it falls in the medium quality level and if it is 20-0, it falls in the low quality level.

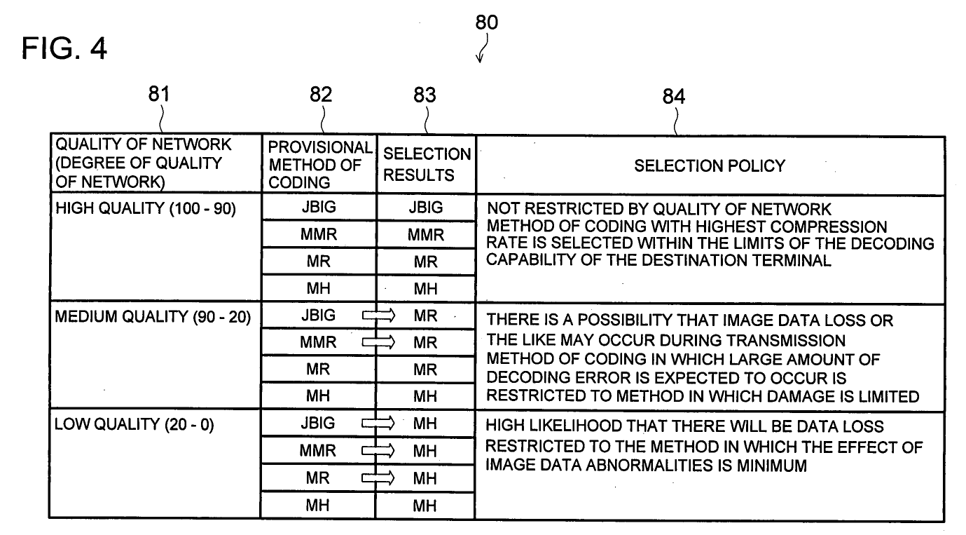

FIG. 4 shows the coding method selection chart 80 which gives an example of the selection criteria used when the image communication apparatus 10 selects the method of coding based on quality of the network.

The coding method selection chart 80 shows which a method of coding is finally selected based on the method of coding with the highest compression rate (called provisional method of coding hereinafter) from among the coding and decoding capabilities shares with the destination terminal as decoding capability and with the apparatus itself as coding capability, as well as based on the quality of the network.

The coding method selection chart 80 includes, starting from the left: a network quality column 81; a provisional coding method column 82 which gives examples of the provisional coding method; a selection results column 83 which gives examples of the method of coding finally selected; and a selection policy column 84 which shows the selection criteria in this coding method selection chart 80.

The network quality column 81 is divided into high quality, medium quality and low quality as described before. The provisional coding method column 82 and the selection results column 83 have listed therein the provisional methods of coding and the final method of coding corresponding to the provisional methods of coding for each level of the network quality column 81. According to the network quality column 81, in the case where the quality of the network is medium and the provisional method of coding is MMR, MR is selected as the final method of coding.

Next, the selection policy for each level will be described more concretely. In the case where the quality of the network is high, the quality of the network is favorable and there is almost no possibility that image data loss will occur during data transmission. Accordingly, the provisional method of coding which was set by capability exchange will be selected as the final method of coding. As a result, the image data is highly compressed, the transmission time is shortened and the data quantity is reduced and thus the load on the network is lightened.

It is to be noted that decoding capability of the destination terminal has both includes both MMR and JBIG, and in the case where a prediction cannot be made as to which the method of coding has the higher compression rate, the image data may be actually coded using both of the methods of coding prior to transmission and the method of coding with the lesser data amount is selected.

In the case where the quality of the network is medium, there is a possibility that the image data loss may occur during transmission. In JBIG and MMR, even if only a portion of the data is damaged, little image reproduction is possible and thus, this type of quality of the network is not favorable. Thus, in the case where the provisional method of coding is JBIG or MMR, MR is selected as the final method of coding as the extent to which lack of data causes damage to the reproduced image is kept within a limited range. (In the case of MR, because coding lends after four lines, the range of damage is within four lines.) It is to be noted that the arrows in the drawing shows where the provisional method of coding changes to a final method of coding which is different.

The coding method selection chart 80 shown in FIG. 4 is created under the presumption that when it is necessary to change/modify the method of JBIG or the MMR coding, changing to MR is possible, but this type of change is not necessarily possible. For example, in the case where the destination computer has only both methods of JBIG and MH coding, MH is selected because MH is the only method of coding in which the extent to which lack of data causes damage to the reproduced image is kept within a limited range (in the case of MH, because coding ends after one line, the range of damage is within one line) when compared with JBIG.

In the case where the quality of the network is low, it can be expected that image data loss and the like will occur with a reasonably high probability. Thus, in the case where the provisional method of coding is JBIG, MMR, or MR, MH is selected as the final method of coding as the size of damage to the reproduced image caused by a lack in image data is kept within the minimum range. In MH, damage is kept to a line unit.

In this manner, a method of coding is selected in which the damage to the reproduced image caused by a lack in image data is in a limited range, to the extent that quality level of the network is low. As a result a method of coding is. selected in which normal images are reproduced at the destination terminal to the greatest extent possible given the quality of the network at the time.

It is to be noted that by selecting a method of coding image data based on the coding method selection chart 80, the method of coding is selected in which the decoded image data loss and decoded errors which occur at the destination terminal, are kept substantially within a limited range. That is to say, because the quality of the network substantially corresponds to the probability of the occurrence of image data loss during transmission, when the methods of coding are used for transmission based conditions of the relevant quality of the network, inference can be made as to the extent of decoded error generation which will occurs at the destination terminal. When viewed in another way, because the quality of the network is known, an inference can be made as to the method of coding that should be used in order to limit the degree of decoding error given the quality of the network. Accordingly, if the boundary values for classifying the quality of the network into high quality, medium quality and low quality based on the circuit quality degree are appropriately set, by simply making a selection based on the coding method selection chart 80, the function of selecting the method of coding in which decoded error and the like is kept within a limited range is realized.

Conversely, in the case where the quality of the network is favorable, it is possible to select a method of coding that is less limited by the lack degree of the decoded error. As a result, it is possible to select a method of coding which has a high compression rate capability. It is to be noted that in either case, it is needless to say that the method of coding is selected based on the degree of the decoded image data loss and the lack degree of the decoded error at the destination terminal.

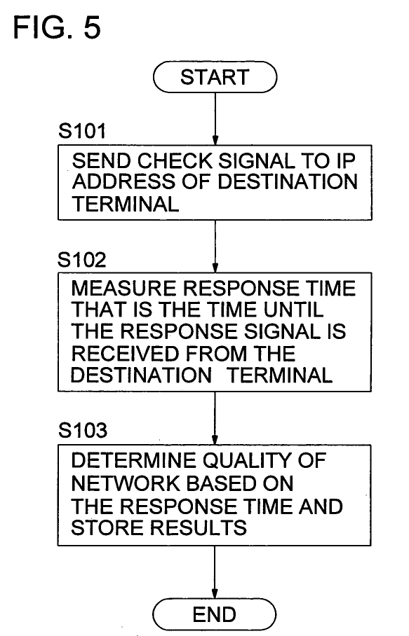

FIG. 5 shows the flow of operation when the checking section 40 checks the quality of the network 60 using the first method.

The checking section 40 transmits the check signal 70 created by the ping command to the IP address of the destination terminal (Step S101). The response time that is the time until the response signal 71 is received from the destination terminal is then measured (Step S102) and the quality of the network is determined based on the response time and the level corresponding to that the quality of the network is stored (Step S103) and the operation ends (END).

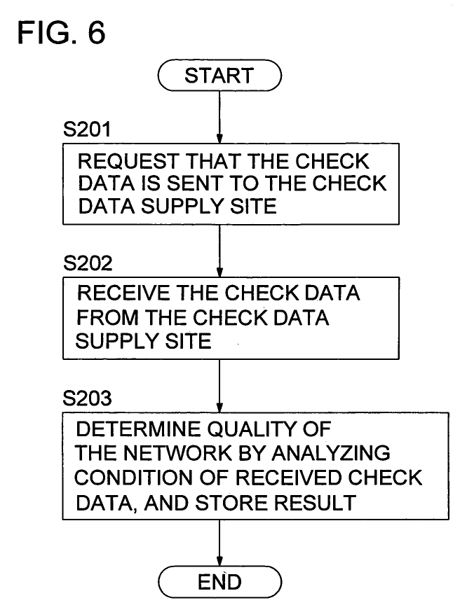

FIG. 6 shows the flow of operation when the checking section 40 checks the quality of the network 60 using the second method.

The checking section 40 request that the check data 73 is transmitted to the check data supply site 67 which is connected to the network 60 (Step S201). The check data supply site 67 that receives this request transmits a predetermined check data 73 to the image communication apparatus 10 that made the request. When the check section 40 receives the check data 73 from the check data supply site 67 (Step S202), the quality of the network is determined based on the whether there is data loss and if any, the proportion thereof, as well as the result of analyzing the state in which the data is received, and the level corresponding to this quality of the network is stored (Step S203) and the operation ends (END).

In FIG. 5 and FIG. 6, the detection section 40 determines the quality of the network 60 by using the first method and the second method independently, but these two methods may be performed and the results of both combined to determine the quality of the network.

Next, the operations performed when the image communication apparatus 10 transmits image data will be described.

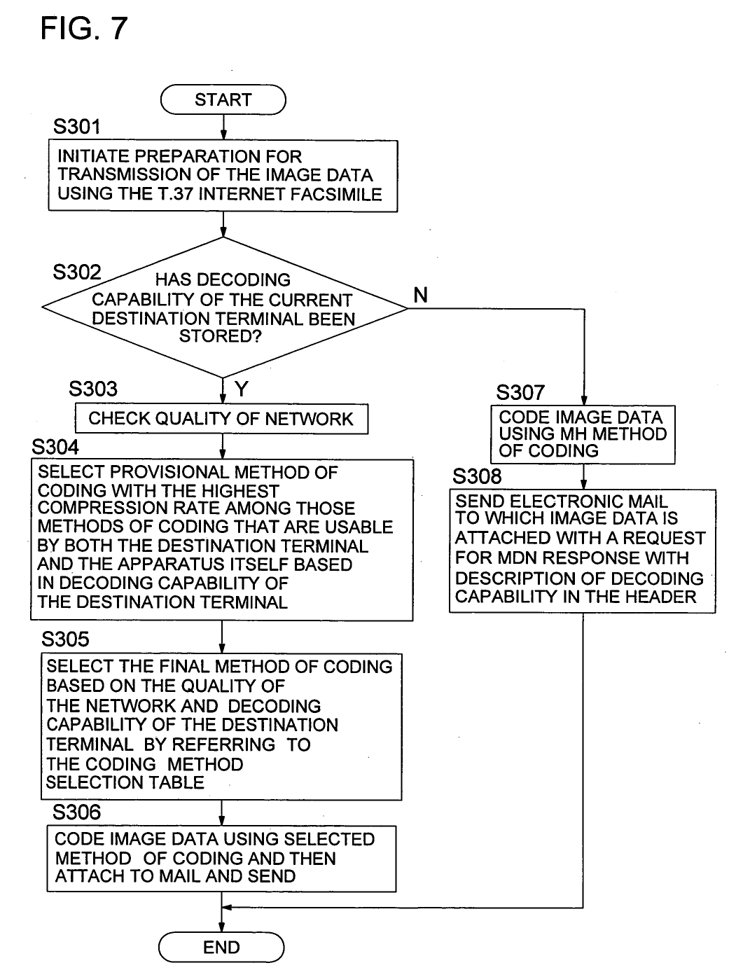

FIG. 7 shows the flow of operations in the case where the communication apparatus 10 transmits image data using the internet facsimile based on T.37.

The communication apparatus 10 which initiated preparation for transmission of the image data by the internet facsimile based on T.37 (Step S301) checks whether the decoding capability of the current destination terminal has been obtained from the MDN response 50 (Step S302).

In the case where the decoding capability had not been stored for some reason such as because image data is being transmitted to the destination terminal for the first time (N in Step S302), image data is coded by MH which is a standard method of coding for the internet facsimile based on T.37 (Step S307). In addition, in order to obtain the decoding capability, image data is transmitted by electronic mail with a request for MDN response in the header, with the expectation of description of the decoding capability of the destination terminal (Step S308) and then the operation ends (END). If full mode is available at the destination terminal, the destination terminal records its own capability in the MDN response 50 and sends it to the terminal from which the request was sent. The terminal from which the request was sent extracts the decoding capability of the destination terminal from the received MDN response 50 and this is recorded at the time of subsequent transmissions (not shown in the drawings).

On the other hand, in the case where the decoding capability of the destination terminal is stored (Y in Step S302), checking of the quality of the network 60 is done by the operations described in FIG. 5 and FIG. 6 (Step S303). In addition, the decoding capability of the destination terminal is obtained from the MDN response 50 and the method of coding with the highest compression rate is selected as the provisional method of coding from among those methods of coding that are usable by both the destination terminal and the apparatus itself. (Step S304)

The selection section 42 selects the final method of coding based on the quality of the network obtained in Step S303 and the provisional method of coding selected in Step S304 by referring to the coding method selection table 80 (Step S305). The image data is then coded using the selected method of coding and then this image data is attached to mail and transmitted to the destination terminal (Step S306) and then the operation ends (END).

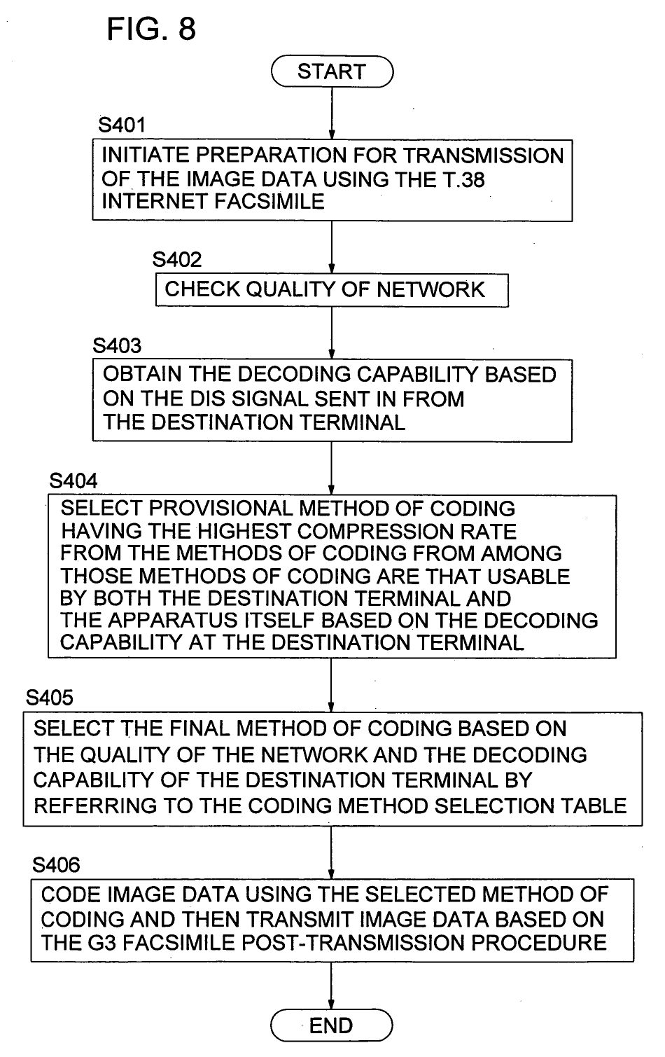

FIG. 8 shows the flow of operations in the case where the communication apparatus 10 sends image data using the internet facsimile based on T.38.

The image communication apparatus 10 which initiated preparation for transmission of the image data by the internet facsimile based on T.38 (Step S401) checks the quality of the network 60 using the operations described in FIG. 5 and FIG. 6 (Step S402).

In addition, the decoding capability at the destination terminal is obtained based on the DIS signal that is transmitted in from the destination terminal (Step S403) and the provisional method of coding having the highest compression rate is selected from among those methods of coding that are usable by both the destination terminal and the sender apparatus itself (Step S404).

The selection section 42 selects the final method of coding based on the quality of the network obtained in Step S402 and the provisional method of coding selected in Step S404 by referring to the coding method selection table 80 (Step S405). The image data is then coded using the selected method of coding and then this image data is transmitted by transmission procedure of the G3 facsimile based on T.30 (Step S406) and then the operation ends (END).

Next, the case in which the quality of the network is checked based on the resend request for the image data and the image is transmitted will be described.

The internet facsimile based on T.38 adapts an error correction function ECM (Error Correction Mode), and the ECM is realized by an image data transmission procedure which is called HDLC (High-Level Data Link Control) procedure. The HDLC is a control procedure which detects the presence of errors such as a lack in data or data damage in frame units.

The destination terminal detects whether there are errors such as data damage in the received frame, and in the case where there is a frame that has errors, a control signal called PPR (Partial Page Request) which is defined by T.30 is transmitted and a request for the frame with the error to be resent is sent to the transmission side. The transmission side that received the PPR signal transmits the frame for which the resend request was received to the destination terminal. However, there is a limit to the frequency of resend requests and when the upper limit is reached transmission itself of the image data is terminated. Thus, when the quality of the network is poor, transmission of the image data is terminated before completion.

However, even for the kind of image quality in which many error frames are generated, damage of reproduced images due to data loss is kept in a limited range and if methods of coding such MR or MH are used, even if the frame with the error is not resent, images with little damage can be sent to the destination terminal.

Thus, the checking section 40 determines the current quality of the network based on the number of frames including errors for which the resend request was received from the destination terminal using the PPR signal or the proportion of error frames with respect to the number of frames transmitted or the frequency with which PPR signals are received. The method of coding is changed based on these results and in addition ECM is removed and communication continued.

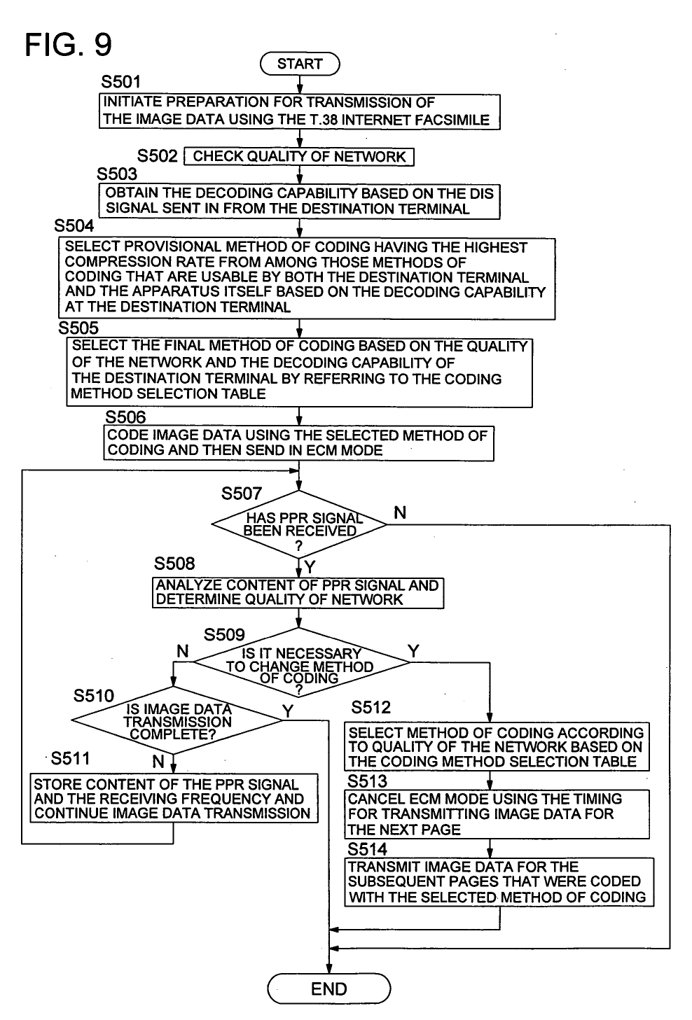

FIG. 9 shows the flow of operations in the case where the quality of the network is checked based on the PPR signal and the image data is transmitted. It is to be noted that in the case where the PPR signal is not received, the quality of the network is favorable and thus a description thereof is omitted. Furthermore description of transmission of the error frame itself is also omitted,

The communication apparatus 10 which initiated preparation for transmission of the image data by the internet facsimile based on T.38 (Step S501) checks the quality of the network 60 based on the operations described in FIG. 5 and FIG. 6 (Step S502). In addition, the decoding capability at the destination terminal is obtained based on the DIS signal that is transmitted in from that destination terminal (Step S503) and the provisional method of coding having the highest compression rate is selected from among those methods of coding that are usable by both the destination terminal and the apparatus itself. (Step S504).

The selection section 42 selects the final method of coding based on the quality of the network obtained in Step S502 and the provisional method of coding selected in Step S504 by referring to the coding method selection table 80 (Step S505). The image data is then coded using the selected method of coding and this is transmitted in EMC mode (Step S506).

In the case where the PPR signal is not received (N in Step S507), the image data is simply transmitted and the operation ends (END). In the case where the PPR signal is received (Y in Step S507), the quality of the network 60 is checked and determined based on the content of the PPR signal (number and proportion of error frames) and the frequency with which the PPR signal is received (Step S508). A determination is then made as to whether it is necessary to change the current method of coding based on the level of the network quality obtained from checking, by referring to the coding method selection table 80 (Step S509).

If it is unnecessary to change the method of coding (N in Step S509) checking is done to determine whether the transmission of the image data is complete (Step S510), and if the transmission is complete (Y in Step S510), the program ends (END).

If the transmission of the image data is not yet complete (N in Step S510), the content of the PPR signal and the frequency with which it was received is stored as data for checking the quality of the network when the next PPR signal is received and transmission of image data continues (Step S511). When the PPR signal is received again (Y in Step S507), the operation proceeds to Step S508, and if another resend request does not come in (N in Step S507), communication ends normally (END).

If it is determined that it is necessary to change the method of coding in the determination performed after receiving the PPR (Y in Step S509), a method of coding is selected based on the coding method selection table 80 according to the quality of the network (Step S512). A control signal for canceling the ECM mode with the timing for transmitting image data for subsequent page is processed with the destination terminal and the EMC mode is cancelled (Step S513). After this, the image data for the subsequent pages that were coded with the method of coding first selected are transmitted (Step S514) and the operation ends (END). It is to be noted that the method of coding selected when the EMC mode is cancelled is either MR of MH, based on the coding method selection table 80.

In this manner, the method of coding is changed to one in which the abnormalities in the image data is unlikely to have the effect of deterioration in the decoded image data and transmission then continues. As a result, it is possible to reproduce an image at the destination terminal which is as normal as possible, with the quality of the network at that point.

The embodiments of the present invention were described above with reference to the drawings, but the specific details of the configuration are not limited to those shown in these embodiments, and modifications and additions that do not depart from the spirit of this invention are included in this invention.

For example, in the embodiments shown in FIG. 7 and FIG. 8, an example is described in which the method of coding for the image data is selected based on the quality of the network and the decoding capability of the destination terminal. However, if the coding capability of the apparatus itself and the method of decoding of the destination terminal are the same, for example, the method of coding for the image data may be selected based solely on the quality of the network.

Also, the configuration may be such that the provisional method of coding is set by the user using the display section 20 and/or the operation section 21.

The methods for checking the quality of the network are not limited to those given as an example in these embodiments. Also, although the check results are converted to the degree of the quality of the network and then classified into levels, the method for enumerating the check results as quality of the network and the method of classification are not limited to those given as examples in these embodiments.

In addition, the methods of coding are not limited to those given as examples. Furthermore, in these embodiments, the method of coding is gradually changed, but when the quality of the network does not exceed a predetermined quality, conversion to the method of coding such as MH and the like in which the effect of data loss on damage to the reproduced image is done at once.

In the embodiments in FIG. 7 and FIG. 8, the timing for checking the quality of the network 60 is directly before image data is transmitted but the timing is not restricted to that of this example. The quality of the network may be checked periodically at a preset timing or checked at any timing by user's operation for pressing a specific button.

In addition, even in the case where the quality of the network is checked immediately before transmitting the image data, a quality of the network can be determined with more reliability by measuring the response time of the response signal 71 with respect to the check signal 70, or performing multiple send requests for the check data 73 or increasing the number in the sample of image data subject to checking.

In addition, the user may be notified of selection of a method of coding whose compression rate is lower than the method of coding that determined by capability exchange due to worsening of the quality of the network 60, using the display section 20.

Furthermore, in the case where a determination is made that even after the method of coding is changed based on the results of checking the quality of the network 60, decoded image data loss or decoded error at the destination terminal is not less than a predetermined value, a caution message indicating that transmission of image data should be terminated or that transmission should be retried at a later time may be displayed.

In addition, in this embodiment, the example of the internet facsimile based on T.37 and T.38 has been described, but this invention is not limited thereto. For example, the common facsimile which uses public telephone lines may also be used.

As described in the foregoing, according to the image communication apparatus embodied in the present invention, the following effect can be attained.

Since the quality of the network is checked and a method of coding is selected based on the result, images can be transmitted using a method of coding that is suitable for the quality of the network at the time of transmission. For example, if a method of coding in which packet loss and the like is unlikely to abnormally affect the decoded image data is selected to the extent that the quality of the network is poor, image in which deterioration is minimized can be transmitted even when the quality of the network is poor.

Disclosed embodiment can be varied by a skilled person without departing from the spirit and scope of the invention.

What is claimed is:

1. A communication apparatus which transmits an image data via a network, comprising:
a checking section which checks a quality of the network;
a selector which determines one of methods of coding in accordance with the quality of the network;
a coding section which codes the image data based on the coding method determined by the selector; and
a transmit section which transmits the coded image data to a desired destination via the network.

2. The communication apparatus of claim 1, further comprising:
a storage section which stores a coding capability information of the desired destination;
wherein the selector determines the coding method in accordance with the quality of the network and the coding capability information.

3. The communication apparatus of claim 2,
wherein the coding capability information is obtained from outside of the communication apparatus.

4. The communication apparatus of claim 3,
wherein the coding capability information is obtained from the desired destination.

5. The communication apparatus of claim 3,
wherein the coding capability information is obtained during a post-transmission procedure.

6. The communication apparatus of claim 3,
wherein the selector selects a predetermined coding method in case that the coding capability information is not obtained.

7. The communication apparatus of claim 1,
wherein the checking section checks the quality of the network before the transmit section transmits the coded image data and/or during the transmit section transmits the coded image data.

8. The communication apparatus of claim 1,
wherein the checking section checks the quality of the network based on a response time that is from a time transmitting a predetermined signal to a predetermined destination till a time receiving a response to the predetermined signal from the predetermined destination.

9. The communication apparatus of claim 8,
wherein the predetermined destination is the desired destination.

10. The communication apparatus of claim 1,
wherein the checking section checks the quality of the network based on a condition for a check data received from a predetermined destination.

11. The communication apparatus of claim 10,
wherein the predetermined destination is a predetermined site.

12. The communication apparatus of claim 1,
wherein the checking section checks the quality of the network based on a response data received from the desired destination.

13. The communication apparatus of claim 12,
wherein the response data relates to a request for re-sending the coded image data by the desired destination.

14. The communication apparatus of claim 1,
wherein the selector selects a coding method where a lack degree in a decoded image data is restricted as the quality of the network is low.

15. The communication apparatus of claim 1,
wherein the selector selects a coding method where a lack degree of a decode error is restricted as the quality of the network is low.

16. The communication apparatus of claim 1,
wherein the selector selects a coding method where a lack degree of a decode error is not restricted as the quality of the network is high.

17. The communication apparatus of claim 1,
wherein the selector selects a coding method in accordance with a lack degree in a decoded image data occurred in the desired destination.

18. The communication apparatus of Claim 1,
wherein the selector selects a coding method in accordance with a lack degree of a decoded error occurred in the desired destination.

19. A method for transmitting image data through a network, comprising the steps of:
checking a quality of the network;
determining one of methods of coding in accordance with the quality of the network;
coding the image data based on the coding method determined in the determining step; and
transmitting the coded image data to a desired destination through the network.

20. The method of claim 19, further comprising the step of:
storing a coding capability information of the desired destination;
wherein the coding method is determined in accordance with the quality of the network and the coding capability information.

21. The method of claim 20,
wherein the coding capability information is obtained from outside of a communication apparatus that transmits the image data.

22. The method of claim 21,
wherein the coding capability information is obtained from the desired destination.

23. The method of claim 21,
wherein the coding capability information is obtained during a post-transmission procedure.

24. The method of claim 21,
wherein a predetermined coding method is selected in case that the coding capability information is not obtained.

25. The method of claim 19,
wherein the quality of the network is checked before the coded image data are transmitted and or during the coded image data are transmitted.

26. The method of claim 19,
wherein the quality of the network is checked, based on a response time that is from a time transmitting a predetermined signal to a predetermined destination till a time receiving a response to the predetermined signal from the predetermined destination.

27. The method of claim 26,
wherein the predetermined destination is the desired destination.

28. The method of claim 19,
wherein the quality of the network is checked, based on a condition for a check data received from a predetermined destination.

29. The method of claim 28,
wherein the predetermined destination is a predetermined site.

30. The method of claim 19,
wherein the quality of the network is checked, based on a response data received from the desired destination.

31. The method of claim 30,
wherein the response data relates to a request for re-sending the coded image data by the desired destination.

32. The method of claim 19,
wherein a coding method, where a lack degree in a decoded image data is restricted, is selected as the quality of the network is low.

33. The method of claim 19,
wherein a coding method, where a lack degree of a decode error is restricted, is selected as the quality of the network is low.

34. The method of claim 19,
wherein a coding method, where a lack degree of a decode error is not restricted, is selected as the quality of the network is high.

35. The method of claim 19,
wherein a coding method is selected in accordance with a lack degree in a decoded image data occurred in the desired destination.

36. The method of claim 19,
wherein a coding method is selected in accordance with a lack degree of a decoded error occurred in the desired destination.
